(19) United States
(12) Patent Application Publication
(10) Pub. No.: US 2015/0354845 A1
(43) Pub. Date: Dec. 10, 2015

(54) OPTIMIZED AIRFLOW DISTRIBUTION SYSTEM

(71) Applicants: Michael A. BROWN, (US); James C. DECKER, Holland, PA (US); ENVIRONMENTAL CONSTRUCTION SERVICES, INC., Philadelphia, PA (US)

(72) Inventors: Michael A. Brown, Blackwood, NJ (US); James C. Decker, Holland, PA (US)

(73) Assignee: ENVIRONMENTAL CONSTRUCTION SERVICES, INC., Philadelphia, PA (US)

(21) Appl. No.: 14/760,120

(22) PCT Filed: Jan. 8, 2014
(86) PCT No.: PCT/US14/10655

§ 371 Date: Jul. 9, 2015

Related U.S. Application Data
(60) Provisional application No. 61/751,117, filed on Jan. 10, 2013.

(51) Int. Cl. F24F 11/00; B23P 19/00

(52) U.S. Cl. CPC F24F 11/0034; F24F 11/0001; F24F 11/006; F24F 11/0079; B23P 19/00; F24F 2011/0041; F24F 2011/0056; F24F 2011/0068

(57) ABSTRACT

An airflow distribution system comprising an occupancy detector, a motorized damper, a ventilation sensor, and a controller; wherein said occupancy detector signals said motorized damper to open when a room is occupied and to close when a room is unoccupied; wherein said ventilation sensor signals said controller to reduce the speed of a fan when less volumetric airflow is needed; wherein said ventilation sensor signals said controller to increase the speed of a fan when more volumetric airflow is needed.

### FIELD OF INVENTION

The present application is generally related to a device for the efficient regulation of airflow within a building, in which modification of airflow to rooms and modification of fan speed or horsepower increases efficiency of said device.

### BACKGROUND OF THE INVENTION

Heating, ventilation and air conditioning (HVAC) systems are used to deliver air to enclosed areas such as rooms in a building. Typically, HVAC systems use ducts and fan(s) to deliver air to the ventilated areas. HVAC systems also generally include dampers that can be used to shut off the flow of air to selected areas of the building. Many HVAC systems have additional components such as air filters; powered exhausts, which force air out of a building; economizers, which mix internal return air with incoming outside air; and energy recovery ventilators, which pre-heat or pre-cool incoming outside air.

HVAC systems must comply with minimum regulatory standards, including minimum ventilation requirements. The commonly used standards of the American Society of Heating, Refrigerating and Air-Conditioning Engineers, Inc. (ASHRAE) require a minimum airflow of 15 cubic feet per minute per occupant.

HVAC systems can expend a great amount of energy, especially in large commercial buildings. Various technologies have been developed to improve the efficiencies of these systems, including U.S. Pat. Nos. 5,909,378, 7,398,821, 7,726,582, 7,797,080, and 7,802,734.

One way to improve the efficiency of HVAC systems in commercial buildings is through the use of expensive devices such as variable air volume boxes. However, these technologies are not suitable for the majority of retrofit applications due to financial and space limitations.

Another method of improving HVAC efficiency is to avoid ventilating rooms that are not occupied. U.S. Pat. Nos. 4,060,123, 5,395,042, and 7,918,406 describe technologies and improvements of ventilation systems utilizing occupancy detection devices. However, cost savings in such systems are minimal unless fan speed is reduced in relation to the decreased need for air volume. In order to maximize energy savings, an integrated system is needed that optimizes fan speed depending upon the number of rooms that need to be ventilated.

Each and every reference cited herein is hereby incorporated by reference in its entirety, where appropriate, for teachings of additional or alternative details, features, and/or technical background.

### SUMMARY OF THE INVENTION

An embodiment of the invention comprises a new and improved airflow distribution system comprising an occupancy sensor, a motorized damper, a ventilation sensor, a fan controller, and pressure-tested and/or sealed ductwork of said airflow distribution system, wherein the occupancy detector signals the motorized damper to close when a room is unoccupied and to open when the room is occupied.

An additional embodiment of the invention is a method of airflow distribution that comprises detecting occupancy of a room, signaling a motorized damper to open or close, sensing a change in airflow metrics that indicates a need for a change in volumetric flow rate, and signaling a controller to modify the speed of a fan.

An additional embodiment of the invention is a method of improving the efficiency of an airflow distribution system comprising connecting an occupancy detector to a motorized damper that opens and closes based on occupancy; and connecting a static pressure sensor to a variable speed drive to modify the speed of a fan upon a change in static pressure.

An additional embodiment of the invention is a method of optimizing an existing airflow distribution system that comprises pressure testing and/or sealing ductwork of the airflow distribution system; installing an occupancy detector, a motorized damper, a ventilation sensor, and a controller; connecting the occupancy detector to the motorized damper such that the occupancy detector signals the motorized damper to close when a room is unoccupied and to open when a room is occupied; and connecting the ventilation sensor to the controller such that the ventilation sensor signals the controller to reduce the speed of a fan when there is a need for decreased volumetric flow rate, and the ventilation sensor signals the controller to increase the speed of a fan when there is a need for increased volumetric flow rate.

An additional embodiment of the invention is an optimized airflow distribution system comprising: an occupancy detector, a motorized damper, a static pressure sensor, and a variable frequency drive; wherein said occupancy detector determines occupancy of a space and signals said motorized damper to open when said space is occupied and close when said space is unoccupied; wherein said static pressure sensor takes measurements of static pressure; wherein said static pressure sensor signals said variable frequency drive in response to changes in static pressure; wherein said variable frequency drive changes the speed of a fan in response to said signal; and wherein said measurements of said static pressure sensor are verified by pressure testing and/or sealing ductwork of said airflow distribution system.

### BRIEF DESCRIPTION OF THE DRAWINGS

FIG. 1 identifies a simplified method diagram of one embodiment of the invention described herein.

FIG. 2 identifies a simplified diagram of one embodiment of the invention described herein.

FIG. 3 identifies a simplified diagram of one embodiment of the invention described herein.

FIG. 4 identifies a simplified diagram of a section of ducts in one embodiment of the invention described herein.

### DETAILED DESCRIPTION OF THE DRAWINGS

The embodiments of the invention and the various features and advantages thereto are more fully explained with references to the non-limiting embodiments and examples that are described and set forth in the following descriptions of those examples. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims.

As used herein, terms such as “a,” “an,” and “the” include singular and plural referents unless the context clearly demands otherwise.

As used herein, the term “about” means within 10% of a stated number.

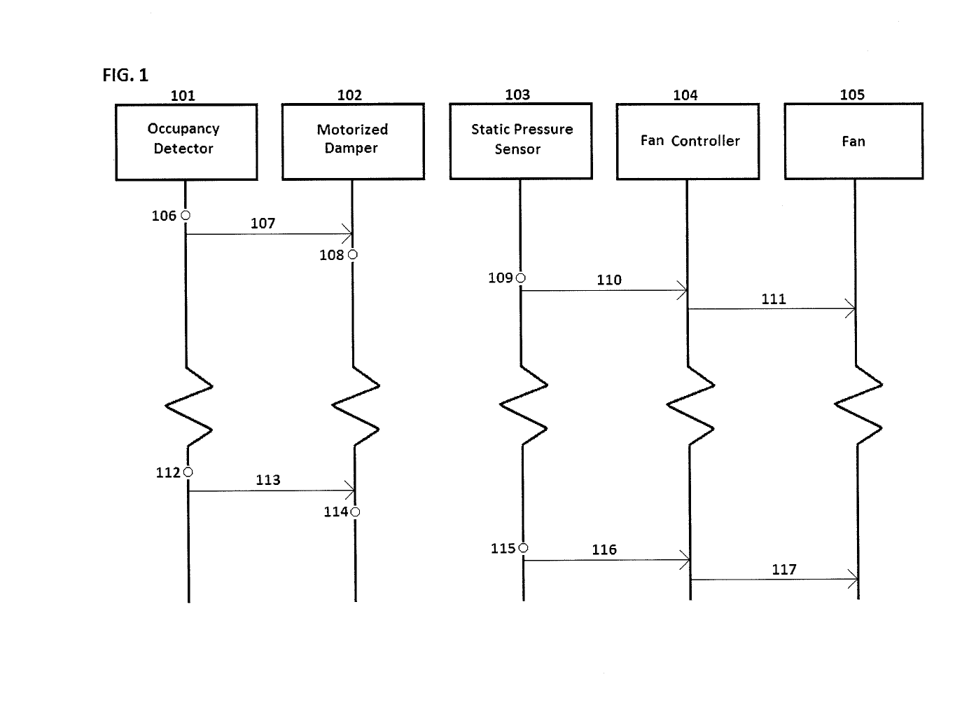

FIG. 1 identifies a simplified method diagram of an embodiment of the invention. An occupancy detector 101 detects 106 that a room has become unoccupied. The term “occupancy detector” includes any device or methodology capable of determining whether a room or other area of a building is occupied. The term includes, but is not limited to, passive infrared detectors, ultrasonic detectors, microwave detectors, door sensors, keycard sensors, or other motion, auditory, or other sensory mechanism, and any combination of these devices.

The occupancy detector 101 signals 107 the motorized damper 102. As used herein, a damper is any device that can reduce and/or completely shutoff airflow within the ducts or to a particular space. A motorized damper is any damper that can be operated by a signal. The motorized damper 102 then closes 108, partially or fully cutting off air to the unoccupied area.

Closing the motorized damper 102 changes the path of the airflow, which in turn changes the airflow metrics. The change in airflow metrics is detected by a ventilation sensor.

In the embodiment represented in FIG. 1, the ventilation sensor is a static pressure sensor 103. However, the ventilation sensor may also be a velocity pressure sensor, a total pressure sensor, an airflow sensor, or any other sensor capable of measuring ventilation metrics that change in response to the opening or closing of a damper. In FIG. 1, the static pressure sensor 103 detects 109 the increase in static pressure due to the closing 108 of the motorized damper 102.

The static pressure sensor 103 then signals 110 the fan controller 104 indicating the increase in static pressure. The fan controller 104 may be a variable frequency drive (VFD), variable speed drive (VSD), or any other technology capable of adjusting fan speed in response to input. A VFD is a device that varies the speed of a motor by varying the frequency to the motor. A VSD is a device that varies the speed of a motor by varying the voltage to the motor. The fan controller 104 reduces 111 the speed of the fan 105 in accordance with the amount of increase in static pressure. Alternatively, the amount of air generated may be modified by replacing the fan, the angle of the fan blades or other mechanism that modifies air volume and also allows for modification of power input to said device.

In this manner, the amount of airflow through the system and the volumetric flow rate of the fan are reduced. The lower volumetric flow rate reduces the needed horsepower in fans for evaporators and condensers. More specifically, the percentage change in fan horsepower is equal to the change in volumetric flow rate to the third power. This is represented by the following formula: BHP₂/BHP₁=(Q₂/Q₁)³; where BHP₁ and BHP₂ respectively represent previous and current break horsepower of the fan, and Q₁ and Q₂ respectively represent previous and current volumetric flow rate. Thus, reducing the flow rate results in substantial energy savings. Moreover, ASHRAE minimum ventilation requirements are not violated because the unventilated areas are unoccupied. Certainly, based on regulations for air flow, amounts of 1, 5 CFM, 7.5, or even 10 CFM may be acceptable in certain circumstances. Additionally, air flow of about 60 CFM or even up to about 100 CFM or about 200 CFM is suitable for ventilation for smoking rooms or other rooms having high ventilation needs. Typically, air flow will be about 10 CFM to about 50 CFM in residential and commercial settings.

When the occupancy detector 101 senses 112 that the room is now occupied, the occupancy detector 101 signals 113 the motorized damper 102. In response, the motorized damper 102 partially or fully opens 114. The opening 114 of the motorized damper 102 will reduce the static pressure. The static pressure sensor 103 detects 115 the drop in static pressure and subsequently signals 116 the fan controller 104. In response to this signal 116, the fan controller 104 increases 117 the speed of the fan 105. The static pressure sensor 103 and fan controller 104 can be calibrated to ensure that occupied rooms receive adequate ventilation that meets ASHRAE regulations or any other desired air flow requirements.

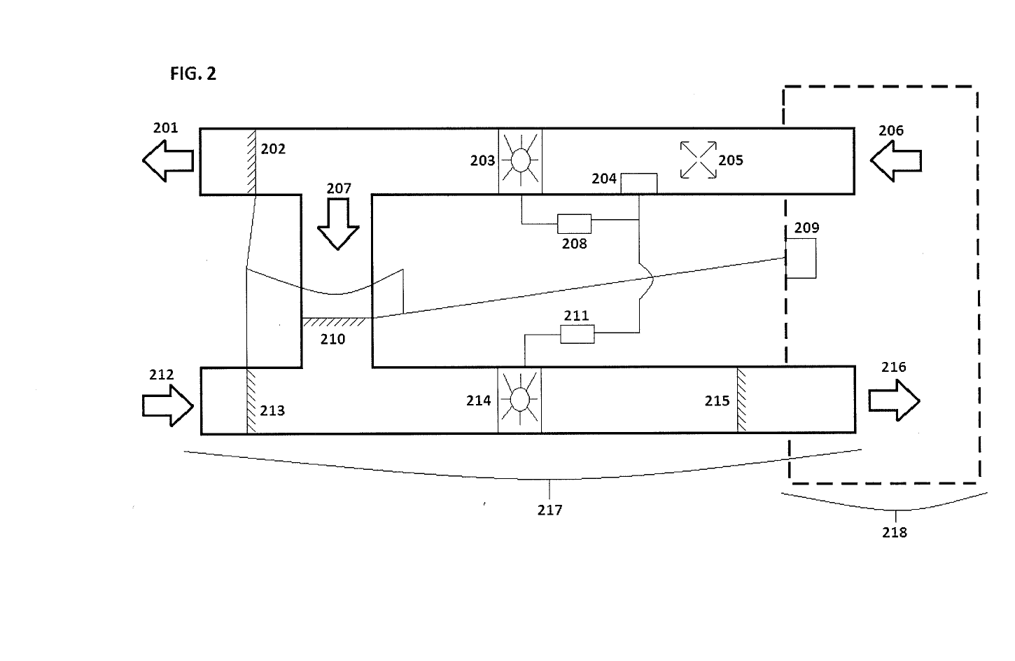

FIG. 2 identifies a simplified depiction of an embodiment of the invention depicting mechanisms in a single room. Incoming external air 212 flows into the ducts 217 and through the external air damper 213. Incoming external air 212 mixes with reused return air 207 and passes through the supply fan 214 and the room damper 215 and enters the room 218 as room supply air 216. Room return air 206 passes through the return fan 203 and splits into exhaust air 201, which exits the ducts 217 via the exhaust damper 202, and reused return air 207, which passes through the return air damper 210 to mix with new incoming external air 212.

If the occupancy detector 209 determines that the room 218 is unoccupied, it signals one or more of the dampers 202, 210, 213, and/or 215 to fully or partially close. As a result, static pressure 205 increases, which is detected by the static pressure sensor 204. The static pressure sensor 204 then signals the return-fan controller 208 and/or the supply-fan controller 211, which reduce the fan speed of their associated fans, 203 and 214, respectively.

If the occupancy detector 209 determines that the room 218 is occupied, it signals one or more of the dampers 202, 210, 213, and/or 215 to fully or partially open. As a result, static pressure 205 decreases, which is detected by the static pressure sensor 204. The static pressure sensor 204 then signals the return-fan controller 208 and/or the supply-fan controller 211, which increase the fan speed of their associated fans, 203 and 214, respectively. While based on a single room, such effects can be expanded to a plurality of rooms, without compromising the effects of an occupancy detector 209 in each room, signaling a damper in said room, sensing static pressure, and modifying fan speed based on the requirements of the system.

Indeed, while each of the sensors may individually respond to inputs, a further embodiment comprises a centralized computer implemented control mechanism is capable of receiving inputs from each of a plurality of rooms. The centralized computer receives input from occupancy detectors, opens and closes dampers, receives input from pressure sensors, and signals a fan to modify speed based on the needs of the entire system. The system is capable of constantly modifying dampers based on occupancy signals, and to accordingly modify fan speed and, and thereby the amount of energy required therein, based on needs of the system.

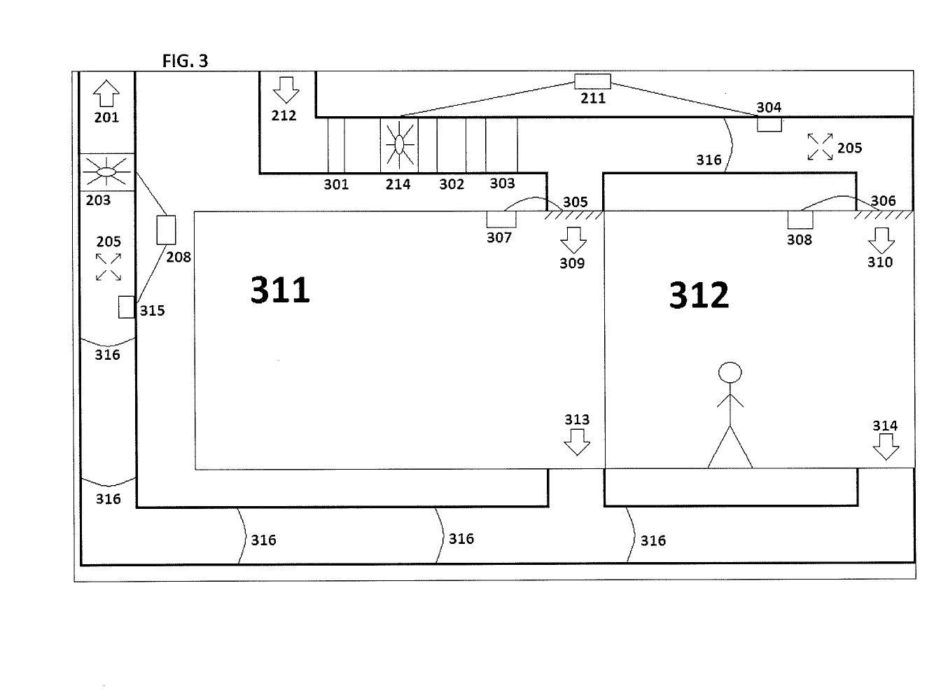

FIG. 3 identifies a perspective side view of an embodiment of the invention. Incoming external air 212 flows into the ducts and through an air filter 301. Joints 316 of the segments comprising the ducts are shown. The incoming external air 212 passes through the supply fan 214, the cooling unit 302, and the heating unit 303. The ducts lead to both an unoccupied room 311 via unoccupied-room damper 305 and an occupied room 312 via occupied-room damper 306.

Occupied-room occupancy detector 308 detects a person in occupied room 312 and signals occupied-room damper 306 to open. Because occupied-room damper 306 is open, occupied-room supply air 310 enters the room and occupied-room return air 314 flows back through the ducts to return fan 203 and is expelled from the building as exhaust air 201.

Unoccupied-room occupancy detector 307 does not detect any people in unoccupied room 311 and signals unoccupied-room damper 305 to close. Because unoccupied-room damper 305 is closed, unoccupied-room supply air 309 and unoccupied-room return air 313 are negligible or non-existent.

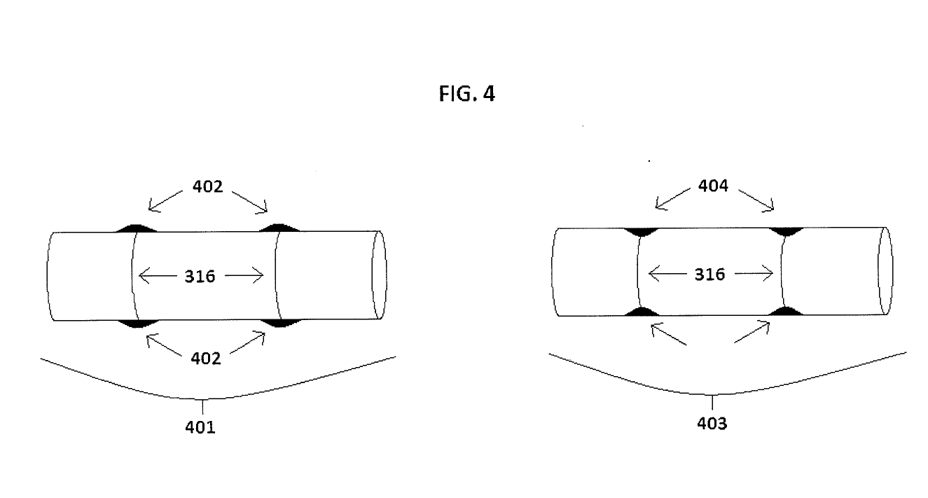

The position of the occupied-room and unoccupied-room dampers, 306 and 305 respectively, affects the total amount of space through which incoming external air 212 must travel. This changes the amount of static pressure 205 within the ducts. The supply-fan sensor 304 and return-fan sensor 315 detect increases or decreases in static pressure 205 and respectively signal the supply-fan controller 211 and return-fan controller 208. The supply-fan controller 211 and return-fan controller 208 increase the fan speed of their respective fans, 214 and 203, upon a drop in the static pressure 205 and decrease fan speed upon an increase in the static pressure 205. Leakage through the joints 316 of the segments and elsewhere can affect static pressure 205 leading to inaccurate readings by the sensors 304 and 315. This effect can be ameliorated by pressure testing and sealing the ducts, as shown in FIG. 4.

The system is further capable of use of multiple heating and cooling units, such that various temperatures may be achieved in different spaces. Indeed, where a plurality of rooms is defined in a space, such as 5, 10, 20, 50, or 100 rooms, or more, centralized control may provide equal heating/cooling and airflow to said rooms, or smaller subsets of rooms may have different control over another set, as is required by the particular installation. Similarly, a single or multiple occupancy detectors may work together for modifying flow to two or more rooms in a particular location.

FIG. 4 identifies a side perspective view of a section of ducts in one embodiment of the invention described herein. The ducts 401 and 403 are split into segments which connect at joints 316. Air leakage often occurs at the joints 316, which causes inaccurate readings of ventilation sensors (not depicted in FIG. 4). Sealing ducts can prevent leakage and ensure more accurate ventilation sensors and a more efficient system.

Ducts can be sealed either externally or internally. External sealant 402 can be manually applied to the outside of the ducts 401 at the joints 316. Often, ducts are located in a drop ceiling. As these are accessible, it is easy to facilitate external or internal sealing of particular joints. Any number of commercially available sealants may be utilized for sealing these areas. Simple mechanical sealants, such as tape or gaskets may be appropriate in certain circumstances, whereas other circumstances require glues, or other solvent based adhesives provided in solid, liquid, or aerosol form to create a seal on, inside, or within the particular joint.

Alternatively, it is known within the art that machines can traverse the ducts 403 and apply internal sealant 404 at the joints 316 or throughout the length of the ducts 403. The use of such an internal sealing machine can be utilized where ducts are either inaccessible, or for ease of sealing the ducts. Further, internal and external sealing can be utilized together.

The invention now being fully described it will be apparent to one of ordinary skill in the art that many changes and modifications can be made thereto without departing from the spirit or scope of the appended claims.

What is claimed is:

1. An optimized airflow distribution system comprising:
an occupancy detector, a damper, a ventilation sensor, and a controller, wherein said occupancy detector determines occupancy of a space and modifies the open or closed status of said damper; wherein said ventilation sensor detects changes in airflow metrics caused by the open or closed status of said damper; wherein said ventilation sensor signals said controller in response to the changes in airflow metrics; and wherein said controller changes the speed of a fan in response to said signal.

2. The optimized airflow distribution system of claim 1, wherein said damper is fully open, partially open, or closed.

3. The optimized airflow distribution system of claim 1, wherein said damper comprises a motorized damper, and wherein said occupancy detector signals said damper to open when said space becomes occupied and said occupancy detector signals said damper to close when said space becomes unoccupied.

4. The optimized airflow distribution system of claim 1, wherein said ventilation sensor comprises a static pressure sensor, wherein said airflow metrics comprise static pressure metrics, and wherein said static pressure sensor takes measurements of said static pressure metrics.

5. The optimized airflow distribution system of claim 4, wherein said static pressure sensor signals said controller to decrease the speed of said fan upon an increase in static pressure, and wherein said static pressure sensor signals said controller to increase the speed of said fan upon a decrease in static pressure.

6. The optimized airflow distribution system of claim 1, wherein said controller comprises a variable frequency drive.

7. The optimized airflow distribution system of claim 1, wherein said controller comprises a variable speed drive.

8. The optimized airflow distribution system of claim 5, wherein the measurements of said static pressure sensor are verified by pressure testing and/or sealing ductwork of said airflow distribution system.

9. The optimized airflow distribution system of claim 8, wherein said ductwork is sealed externally.

10. The optimized airflow distribution system of claim 8, wherein said ductwork is sealed internally.

11. A method of optimizing an airflow distribution system comprising:
a. detecting the occupancy of a space;
b. signaling a motorized damper to close in response to the space becoming unoccupied or open in response to occupancy;
c. detecting static pressure in the airflow distribution system; and
d. modifying volumetric flow rate in said airflow distribution system in response to a change in static pressure.

12. The method of claim 11, wherein said volumetric flow rate is increased by a variable frequency drive increasing the speed of a fan, and wherein said volumetric flow rate is decreased by said variable frequency drive decreasing the speed of a fan.

13. The method of claim 12, wherein said variable frequency drive decreases the speed of said fan upon receiving a signal from a static pressure sensor indicating that static pressure has increased; and wherein said variable frequency drive increases the speed of said fan upon receiving a signal from said static pressure sensor indicating that static pressure had decreased.

14. The method of claim 13, further comprising improving the accuracy of said static pressure sensor by pressure testing and/or sealing ductwork of said airflow distribution system.

15. A method of improving the efficiency of an airflow distribution system comprising:
a. connecting an occupancy detector to a motorized damper such that said motorized damper opens when a room is occupied and closes when said room is unoccupied; and
b. connecting a static pressure sensor to a variable speed drive such that the variable speed drive decreases the speed of a fan upon an increase in static pressure, and the variable speed drive increases the speed of a fan upon a decrease in static pressure.

16. The method of claim 15, further comprising:
a. installing an occupancy detector; and
b. installing a motorized damper.

17. The method of claim 15, further comprising:
a. installing a static pressure sensor; and
b. installing a variable speed drive.

18. The method of claim 15, further comprising pressure testing and/or sealing ductwork of said airflow distribution system.

19. The method of claim 15, further comprising:
a. installing an occupancy detector;
b. installing a motorized damper;
c. installing a static pressure sensor;
d. installing a variable speed drive; and
e. pressure testing and/or sealing ductwork of said airflow distribution system.
